(19) United States
(12) Patent Application Publication
(10) Pub. No.: US 2024/0165888 A1
(43) Pub. Date: May 23, 2024

(54) NON-DESTRUCTIVE DATA ACQUISITION METHOD FOR IOT DEVICES

(71) Applicant: BOARD OF REGENTS, THE UNIVERSITY OF TEXAS SYSTEM, AUSTIN, TX (US)

(72) Inventors: Albert VILLARREAL, San Antonio, TX (US); Robin VERMA, Huntington, WV (US); Oren UPTON, San Antonio, TX (US)

(73) Assignee: BOARD OF REGENTS, THE UNIVERSITY OF TEXAS SYSTEM, AUSTIN, TX (US)

(21) Appl. No.: 18/512,313

(22) Filed: Nov. 17, 2023

Related U.S. Application Data
(60) Provisional application No. 63/426,643, filed on Nov. 18, 2022.

(51) Int. Cl. B29C 64/393; B33Y 50/02; B33Y 80/00; G16Y 20/20; G16Y 40/20

(52) U.S. Cl. CPC B29C 64/393; B33Y 50/02; B33Y 80/00; G16Y 20/20; G16Y 40/20

(57) ABSTRACT

A method and system for downloading the information stored on an IoT device is presented. All in-system programming pins are identified by inspection with visible light or using a computed tomography scan of the device using X-radiation. Based on this inspection, a 3D fixture is fabricated that accommodates spring-loaded pin connectors for contacting the identified in-system programming taps on the main printed circuit board of the device. The 3D test jig, in conjunction with a logic analyzer, can extract data from the internet of things (IoT) device.

### CROSS-REFERENCE TO RELATED APPLICATIONS

The present invention claims the benefit of priority to U.S. Provisional Application No. 63/426,643, filed Nov. 18, 2022, which is incorporated herein in its entirety.

### BACKGROUND OF THE INVENTION

The present invention relates to methods and systems for extracting information from Internet of Things (IOT) devices without completely disassembling the devices. Smart speakers have become a common part of the modern household and it other IoT devices appear to be rapidly proliferating. Such devices often include an AI-powered Intelligent Voice Assistant to communicate with users. As an example, the Amazon Echo Dot is a popular smart speaker that extends the above stated functionality by acting as a communication hub for other IoT and mobile devices within its local network. The nature and volume of data that an IoT device handles make it a potential source of evidence, if one is seized for a digital forensics investigation. Researchers and practitioners have explored various techniques to extract data from these IoT devices. However, traditional methods make changes to the physical device and/or its data, which is undesirable from a digital forensics perspective.

Accordingly, a need arises for a non-destructive methodology for extracting data from IoT devices.

### SUMMARY OF THE INVENTION

Aspects of the disclosure relate to systems and methods for downloading of stored information on an internet of things device without powering up the device.

A method and system for downloading the information stored on an internet of things (IOT) device is presented. All in-system programming pins are identified by inspection with visible light or using a computed tomography scan of the device using X-radiation to see inside the circuit board. Based on this inspection, a 3D fixture is fabricated that accommodates spring-loaded pin connectors for contacting the identified in-system programming taps on the main circuit board of the IoT device. The 3D test jig, in conjunction with a logic analyzer, can extract data from the IoT device.

In an embodiment, a 3D test jig for extracting information from an IoT device may be fabricated using 3D printing.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and the invention may admit to other equally effective embodiments.

FIG. 1 illustrates pseudo-code for a part of the method.

FIG. 2 illustrates a flow chart of the method.

FIG. 3 illustrates memory chip location on a printed circuit board (PCB).

FIG. 4 illustrates memory chip location on a PCB.

FIG. 5 illustrates memory chip location on a PCB.

FIG. 6 illustrates removal of a chip from a PCB.

FIG. 7 illustrates the contact pins of a memory chip.

FIG. 8 illustrates the contact pins of a memory chip.

FIG. 9 illustrates contact pin locations on a PCB

FIG. 10 illustrates a CT scan of a PCB.

FIG. 11 illustrates location of two pins on a PCB

FIG. 12 illustrates microsoldering to contact pins of a memory chip.

FIG. 13 illustrates a test jig for contacting soldered bumps on a PCB or a contact pins on a chip.

FIG. 14 illustrates close up of pogo pins contacting solder bumps on a PCB.

FIG. 15 illustrates close up of pogo pins contacting solder bumps on a PCB.

FIG. 16 illustrates a test jig with pogo pins and a connector.

FIG. 17 illustrates a logic analyzer connected to a test jig applied to a memory chip from a smart speaker.

FIG. 18 illustrates a frontal view of an alternative test jig.

FIG. 19 illustrates a perspective view of an alternative test jig.

FIG. 20 illustrates a side view of an alternative test jig.

Other features of the present embodiments will be apparent from the Detailed Description that follows.

### DETAILED DESCRIPTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical, and structural changes may be made to the embodiments without departing from the spirit and scope of the present teachings. The following detailed description is therefore not to be taken in a limiting sense, and the scope of the present disclosure is defined by the appended claims and their equivalents.

Smart speakers are one of the biggest selling Internet of Things (IOT) device types in the world. The global sale of smart speakers was an estimated 146.9 million units in 2019. Each of these smart speakers hosts an ‘Intelligent Voice Assistant’ that receives voice commands from the user. The voice assistant provides verbal information back or executes instructions on other devices in the smart home network. Statista.com estimates that 4.2 billion digital voice assistants are being used in devices around the world as of 2020. The same report also estimates that there are 110 million virtual assistant users in the United States alone. Amazon is the current market leader in the global smart speaker market with a 21.6 percent share in 2020.

An Amazon Echo Dot version 2 is a good example of a smart speaker. These devices typically use eMMC/eMCP chips as their primary storage (eMMC=embedded multimedia card and cMCP=embedded multichip packages). All the ISP (in-system programming) pins may be identified using the Computed Tomography (CT) Scan imagery of the main PCB (printed circuit board) of the device. A 3D fixture may be created that accommodates pogo pin connectors to create contact with the already identified ISP taps on the main PCB. Such a 3D test probe jig can extract data from an IoT device's memory chip using an eMMC reader.

Amazon's smart speaker product line includes various devices such as Echo, Echo Dot, Echo Show, Echo Studio, and Echo Flex. Some of these devices including the Echo, Echo-Dot, and the Echo Show have evolved over the last few years, resulting in different versions being produced. Echo Studio and Echo Flex were launched in 2019 and are in their first generation. This disclosure uses Amazon Echo Dot version 2 as an example, although the methods, techniques, and systems may equally well be applied to the extraction of data from other IoT devices.

Amazon Alexa is an ‘Intelligent Voice Assistant’ that allows a user to manage all Amazon supported IoT devices connected within the smart home or smart office device pool. All IoT devices in the device pool communicate with each other over a stable local Wi-Fi connection or other wired or wireless communication channels. When a user activates Alexa with the appropriate verbal commands, the Alexa Voice Service (AVS) system transmits the verbal command to the central Alexa system hosted in the cloud-based Amazon web services to make decisions on how to verbally communicate with the user or handle IoT devices in the pool. The voice recognition and interpretation used in the Alexa system requires robust computing resources, which cannot fit in the smart speaker and therefore the computing is done in the cloud. The smart speaker is a small relatively resource-constrained device like the Echo Dot, which includes a microphone and speaker, a shell enclosing other components such as a circuit board with limited memory, storage, and processing power. The small device primarily needs to capture the voice commands, forward them to the cloud, and then playback a response to the user. The Echo Dot version 2 is one of the most common Alexa devices, so analysis of this device forms the main example described in detail below.

IoT devices are potentially important devices from a digital forensics perspective, because they are so common in the home and office environment. If a smart home or smart office environment setup includes an IoT device, then it may be useful for a digital forensics investigator to know what potential evidence may be gathered from this device and also how to collect such evidence. Currently, forensic analysis has focused on the data stored in the cloud, communication between the device and the cloud, and some analysis of data on the device itself, which can be collected through chip-off data extraction methods. Similarly, other IoT devices in a smart home and smart office environment could be potential sources of digital evidence. In the particular example described below, and Amazon Echo Dot version 2 as examined and the methods, techniques, and systems of this disclosure are applied to extract data from its onboard memory chip without either destroying the device or altering the data stored.

Standard methods involved in removing the chips can damage the device and also alter the data stored on the chip, which puts potential evidence at risk. Chip-off extraction in digital forensics is considered to be a destructive method for data extraction, because it removes the memory chip from the circuit board. So, this paper examines a method, which extracts the data without the associated risks of chip-off methods.

Interest in forensic data collection from IoT devices in general, and the Echo Dot specifically, is increasing. One of the first times an Echo Dot was seized as evidence, occurred in 2015, when law enforcement seized an Echo Dot as evidence in a murder investigation in Bentonville Arkansas. Ultimately, the evidence on the device itself was not beneficial, and the case was eventually dropped, but it was a precedent-setting case. Amazon pushed back on the initial court requests for evidence stored in the cloud as being too broad. An Amazon Echo was seized in a double homicide case in January 2017 in Farmington, NH. It is not clear what evidence came from the forensic analysis of the device from news articles, but voice recordings from Amazon included some statements to Alexa from the murder suspect, and these statements were used in the case to establish that he spent significant time at the home in the days leading up to the murder. In the first six months of 2020, Amazon responded to 3,105 court orders, warrants, and subpoenas from the US, with an additional 539 requests from outside the US. Amazon does not provide the detail to know how many of these might be related to requests for data related to Alexa devices, but it is quickly becoming normal for law enforcement to make requests related to these devices.

Although other solutions to extract stored data from IoT devices exist, they destroy the device in the process, typically by heating the solder until the chip can be removed from the printed circuit board. In the present disclosure, a non-destructive method is described which may be used to extract data from memory from an IoD device. In the example described below the IoT device is an Echo Dot version 2, and the memory comprises an embedded Multimedia Card (cMMC) chip.

Forensic Data Retrieval from NAND Chips

Maintaining the integrity of data is a top priority in digital forensic analysis. Identifying tools or methods, which can improve the integrity of collecting forensic data is vital to the improvement of forensic research. When data is collected from IoT devices like the Echo Dot, and many other devices without clear interfaces for data extraction and unknown circuit board traces, a common method is removing the memory chips and reading the data directly from the chip, a process known as “chip-off” analysis. This method poses some inherent risks. Heat-based chip removal methods may introduce raw data errors in NAND flash memory's resident data during the chip-off process. Using a ‘read-retry’ mechanism, available on Multi-Level Cell (MLC) NAND chips, can reduce such errors. The ‘read-retry’ mechanism may be implemented as a vendor-specific operation that adjusts NAND flash memory cells' threshold voltage to minimize bit errors during the heating and removal of the chip from the PCB. Bit-errors in NAND chip's resident data may also increase after a forensic chip-off procedure. If the chip-off procedure fails (e.g. solder flows to connect pins on the chip which would not normally be connected), this may alter the data or make the chip unreadable. There is not really a safe temperature range which can guarantee a successful chip-off read.

Thermal-based chip-off procedures involve risk and may not be 100% successful. Other researchers have demonstrated that chip-off extraction resulted in damage to 14 chips out of a research sample of 258 chips. This means that there may be cases when the forensic investigator is unable to read from the NAND chip (the memory chip) after the thermal-based chip-off process. These failures can be critical in digital forensic investigations that depend on evidence from the respective devices from which these chips are analyzed through chip-off analysis.

Because there are risks, it is important to explore other methods for collecting forensically sound data from IoT devices. This will become even more important in cases where the manufacturer has purposely designed the device to prevent reverse engineering or simply not made electronic schematics of the PCB or the chips public. There is a need for non-destructive chip reading methods for the eMMC chips that guarantee a successful data read from the respective chips with lower risk and higher potential data integrity. A non-destructive way to read data from an IoT's memory chip (e.g. from the Echo Dot 2's eMMC chip) is presented in this disclosure.

IOT Smart Speaker Forensics

Other researchers have provided a digital forensic investigation model that can be used to gather potential pieces of evidence from the IoT devices. This investigation model was demonstrated using modelling an Amazon Echo simulated on a Raspberry Pi.

Others have also proposed a Cloud-based IoT Forensic Toolkit or ‘CIFT’ for short, that can identify, acquire, and analyze potential evidence from the Amazon Alexa Ecosystem. This toolkit aimed to collect artifacts from the hardware device, network, client-side, and cloud-related artifacts. The above stated research has not explored the actual hardware data acquisition from an Amazon Echo device. Detailed information about the board layout and hardware components included in the Echo Dot 2 may be publicly available.

The methods, systems, and techniques described here focus on the actual IoT hardware and software, rather than an emulation of an IoT device.

The overall layout of an AI-based smart speaker ecosystem and network traffic analysis to and from these speakers has been performed by others, although they did not explicitly include Amazon products in their work. Some of the same researchers also performed a chip-off operation on Amazon Echo Dot (i.e. removal of the chip from the PCB), followed by certificate and proxy injection into the flash memory. Finally, they perform a re-balling operation to attach the NAND chip back to the mainboard. This procedure helped them to intercept the communication between the Echo Dot and the Amazon cloud. However, the Echo Dot uses Secure Socket Layer (SSL) pinning, meaning that all communications from that device are encrypted, precisely to prevent such man-in-the-middle attacks. And thus, the authors were only able to obtain the Amazon cloud server addresses. The authors tried the same with Alexa-Pi, but the results were the same and they were only able to capture the encrypted communication.

Other researchers used Raspberry Pi to emulate a version of the Amazon Echo Dot 2. There are significant differences between the actual hardware of the Raspberry Pi and the Echo Dot 2 circuit board and chips. This motivated the study of forensic techniques that could be used to collect data directly from the chips of an IoT device. The last two research papers discussed the chip-off technique for data extraction, but showed the risks of using such destructive methods. This disclosure focuses on avoiding the risks of chipoff analysis by describing non-destructive methods of data extraction.

Others have highlighted that ‘data acquisition from IoT devices does not follow a standardized procedure that is forensically sound’ and that the data stored in such systems is valuable as evidence. This disclosure presents a solution to these problems.

PCB Testing Techniques for Digital Forensic Investigation Purposes

In-System Programming (ISP), also referred to as In-Circuit Serial Programming (ICSP), is designed to read the onboard embedded Multi-Media Card (eMMC) and embedded Multi-Chip Package (cMCP) chips without invoking the CPU. Read and write operations can be performed directly on the Ball Grid Array (BGA) pin connections of eMMC/eMCP chips using the ISP pins. There are two ways described by others in which ISP connections can be used to dump the data from a given eMMC/eMCP chip. The first method is to read from the BGA pins of an eMMC chip that has been removed from the main printed circuit board (PCB). This method is a destructive way of extracting data using ISP connections. The second method uses micro-soldering to attach wires to locations on the board that connect to the ISP pins of the eMMC chip. This method is a relatively non-destructive way of extracting data from the chip. Both of the above stated techniques have been used by digital forensic investigators to extract data from mobile phones. There are micro-soldering experts in law enforcement agencies who use their specialized knowledge and experience to carry out these techniques. They also share the ISP pinout information of specific mobile phones with their fellow investigators. Websites like ‘www.emmcpinouts.com’ provide pinout information and detailed documentation about selective make and models of smartphones, tablets, and GPS devices to their paid subscribers. However, a general online repository for ISP pinout information and documentation related to IoT devices was not identified. The current work focuses on the second method, where the micro-soldering steps have been replaced through the use of pogo pins to make connections with the onboard ISP connections.

Even though the information about ISP pinouts of individual mobile devices is available within the digital forensic community, it takes a great level of expertise for an investigator first to learn those techniques and then use them on the devices they wish to work on. There is no alternative practical solution, that could be used by an ordinary forensic investigator, to extract data from such devices without having micro-soldering expertise. So, a secondary goal is to develop a solution that ordinary digital forensic investigators can use. PCB manufacturers also use non-destructive techniques to collect and validate data from chips to test and ensure that the device is functioning properly before it is shipped. In-Circuit Testing (ICT) and Functional Testing (FCT) are the two most common methods for testing a PCB. Other testing techniques include flying probe testing, automated optical inspection, burn-In testing, X-Ray inspection, and more.

There is no academic literature on the development of nondestructive PCB testing techniques for the forensic investigation of IoT devices. This disclosure describes techniques that may collect data directly from the eMMC chip of an IoT device, using the Echo Dot 2 as an example, but doing so in a non-destructive manner, without chip-off risks. A mixed approach that takes inspiration from the In-Circuit Testing and the X-Ray Inspection technique is described. The proposed solution uses a 3D printed fixture with pogo pins, which resembles the ‘In-Circuit Testing’ technique. Moreover, a CT-Scan was used to find the hidden ISP pins that manufacturers can deliberately obfuscate to make data extraction from the device inherently more challenging. This method is like an extension of the ‘X-Ray Inspection’ technique.

Methodology

A generic framework for creating a nondestructive way to extract data from the eMMC/eMCP chip used in IoT devices has been developed. A Test Probe Jig, a device-specific fixture, which may be 3D printed, is obtained as the end-result after following the framework's procedures. The Test Probe Jig for a given IoT device holds pogo pins on ISP contact points on the device's PCB for directly interacting with its eMMC/eMCP chip, bypassing the CPU.

The framework uses at least two donor devices (identical copies) per target IoT device to validate the method. If a researcher or the practitioner successfully creates a Test Probe Jig for a given IoT device, they can easily share their work with peers by sending them, for instance, a 3D printing file of the jig so that others may print their own jigs for the same IoT device. (Alternatively the actual test probe jig may be sent, but the files for making the jig can be sent electronically to many others and so avoids the complications of shipping an actual jig.) So, developing a non-destructive Test Probe Jig for a particular IoT device is a one-time effort for the research and practitioner community.

The use of a Test Probe Jig fixture makes it easy for new and relatively inexperienced investigators to investigate a given IoT device. Currently, only experts can understand and implement advanced data extraction methods like chip-off and ISP microsoldering. The Test Probe Jig greatly reduces the complexity of this problem, as a new or inexperienced investigator only needs a serial reader device to read from the IoT device's eMMC/eMCP.

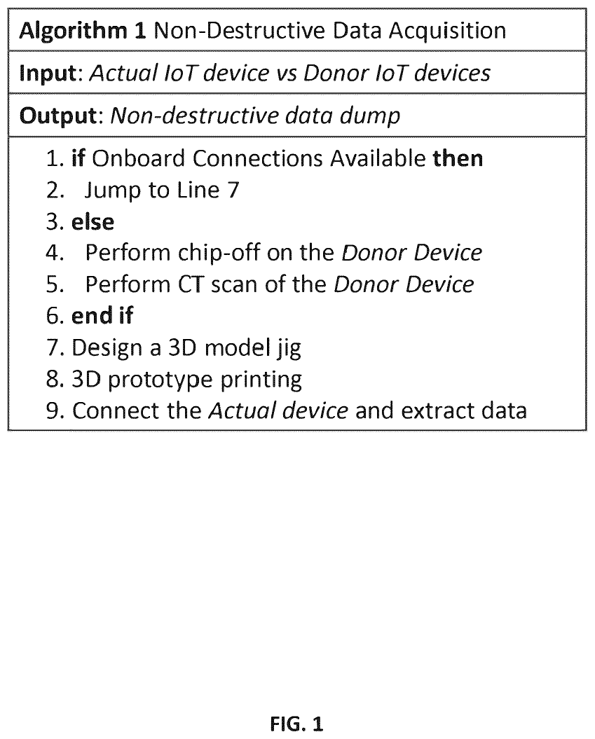

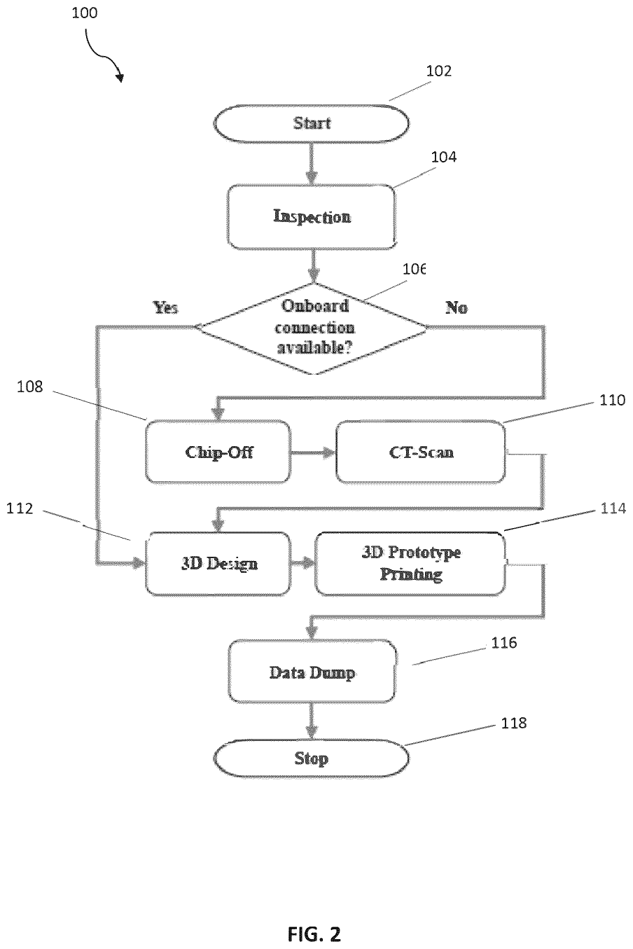

The generic algorithm for acquiring data is shown in FIGS. 1-2. FIG. 1 illustrates Algorithm 1 in pseudo-code format. If there are available online connections for reading out the memory, then these connections may be used to read the memory. If not, then the memory chip may be removed from the PCB of a donor device, as opposed to the actual device of interest, and a CT scan may be performed of the donor device. Based on the results of the CT scan, a 3D jig model may be created, and then a prototype connecting jig may be fabricated. The jig may be used to connect to the memory of the actual device and the data may then be extracted.

A framework is also shown as a flowchart in FIG. 1. The aim of this disclosure is to present a non-destructive method to extract data from an IoT device, such as the Amazon Echo Dot 2. The process 100 starts at step 102. At step 104, the IoT device's hardware is inspected. Whether the IoT device has an onboard connection available is evaluated in step 106. If the IoT device does have an onboard connection available, then the process moves to step 112. If there is no onboard connection available, then the process moves on to step 108, the memory chip is removed from the PCB (“chip-off”). At step 110, the PCB receives a CT scan to identify any hidden connections. At step 112, a 3D design for a testing jig is created. At step 114, a prototype test jig is 3D printed. At step 116, the test jig is employed to perform a data dump of the data on the memory card. The process for retrieving the contents of the memory then ends at step 118. The overall process first investigates the device's hardware, followed by extraction of the data. Subsequently the data may be analyzed.

In an embodiment, the following equipment and resources may be used:
1) At least one IoT device may be used.
2) Information about the BGA pinouts of the respective eMMC chip.
3) Voltage checking hardware (like a logic analyzer, oscilloscope, or multimeter) to inspect and verify the individual ISP pin and voltages.
4) A Stercolithography (SLA) or Polylactic Acid (PLA) 3D printer.
5) eMMC readers like EasyJTAG or RIFF Box.

In the examples given in this disclosure, multiple, identical IoT devices were used to confirm the validity of this method. To test the accuracy of this method, duplicate IoT devices were employed to confirm proper extraction the information stored in the memory chip. One of the duplicate devices had the integrated circuit memory chip removed (the chipoff method), followed by a CT-Scan of the printed circuit board (PCB). A second duplicate device used micro-soldering to ISP connections to read out the data. These methods and duplicate devices were used for comparison and confirmation of the efficacy and accuracy of this method.

Details about these components and the context in which they are used in the current work are given in the text below and the accompanying figures. As noted above two devices were used as controls to carry out the chip-off analysis, CT scan imaging, and the ISP micro-soldering in order to obtain sufficient information for developing the new method which uses a Test Probe Jig. Then the Test Probe Jig was used to extract data from the evidence device.

An exemplary investigation process may comprise the following steps:
1) Gathering information about the device;
2) Concentrating on the memory;
3) Finding a memory reading method: ISP
4) Locating the ISP pins using CT Scan
5) Verifying ISP connections
6) Developing non-destructive reading mechanism: Test Probe Jig
7) Obtaining the data dump.

To explain the method below, an Echo Dot 2 will be used as an exemplary IoT device.

Gathering information about the device: The hardware investigation was started with an FCC ID lookup for the Echo Dot 2 on the Internet. This is often a very useful first step when analyzing IoT devices. In this instance the analysis of the data provided by the FCC ID search was not helpful. The case of the Echo Dot 2 was opened and all hardware components and chips on the Echo Dot 2's main PCB were visually inspected to determine their role. Table I shows details about these chips.

TABLE I
Integrated Circuit Chips on the Echo Dot 2 Boards

| Chips | Function |
|---|---|
| Mediatek MT6625N | 4 in 1 Wi-Fi, Bluetooth, FM and GPS chip |
| Mediatek MT8163v | 64-bit Quad-core ARM Cortex-A53 MPCore |
| Micron 6PA98 JWB30 | 4GB LPDDR3 memory module |
| Mediatek MT6323LGA | Power Management IC |
| DAC 32031 TI 6AK D6KE | Digital to Analog converter |

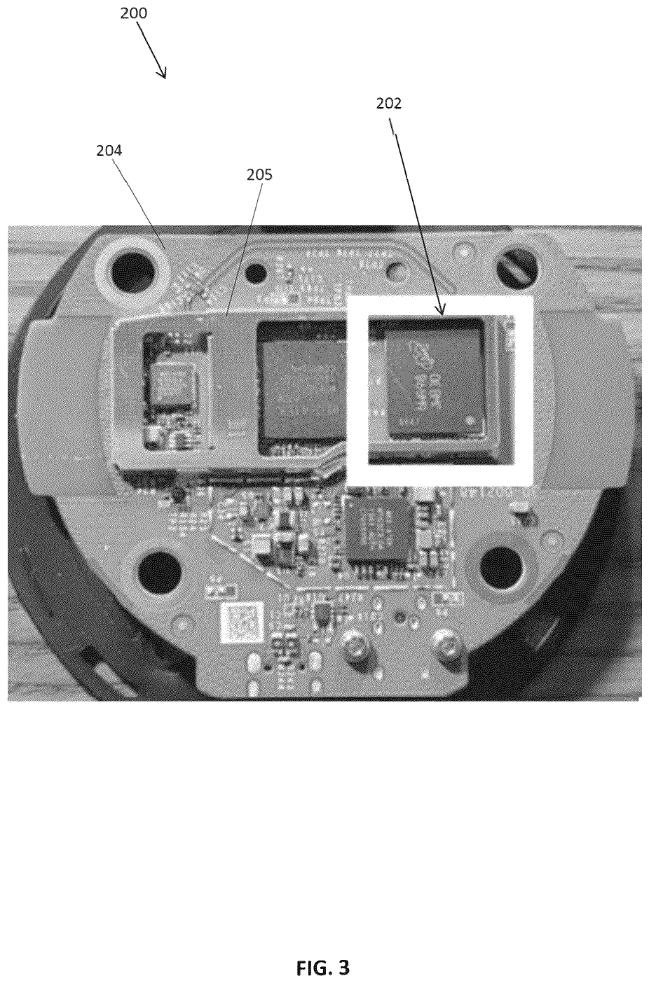

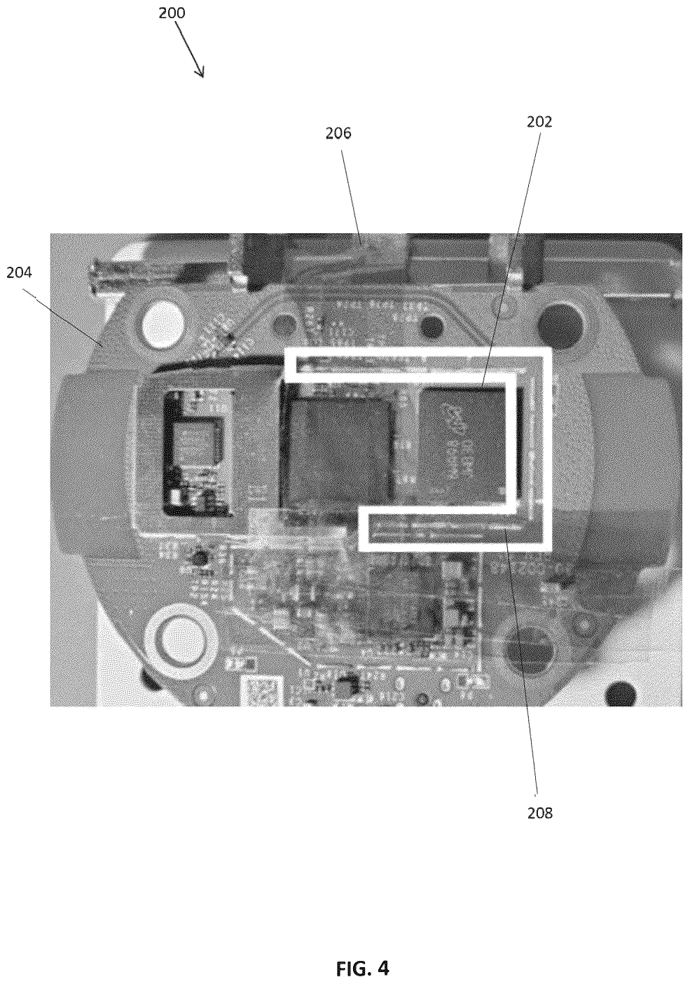

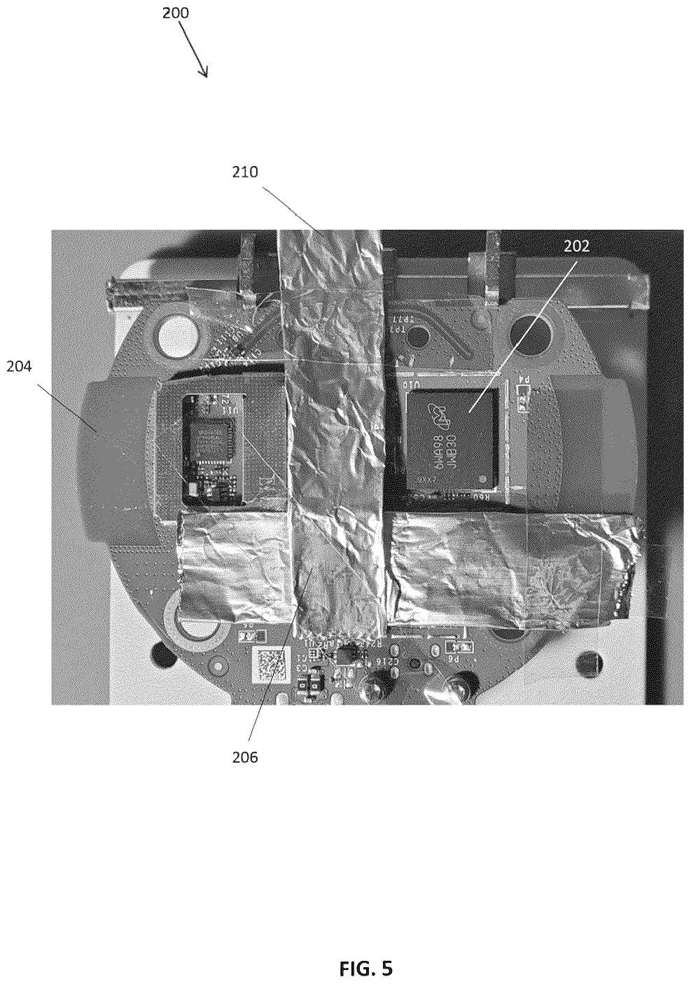

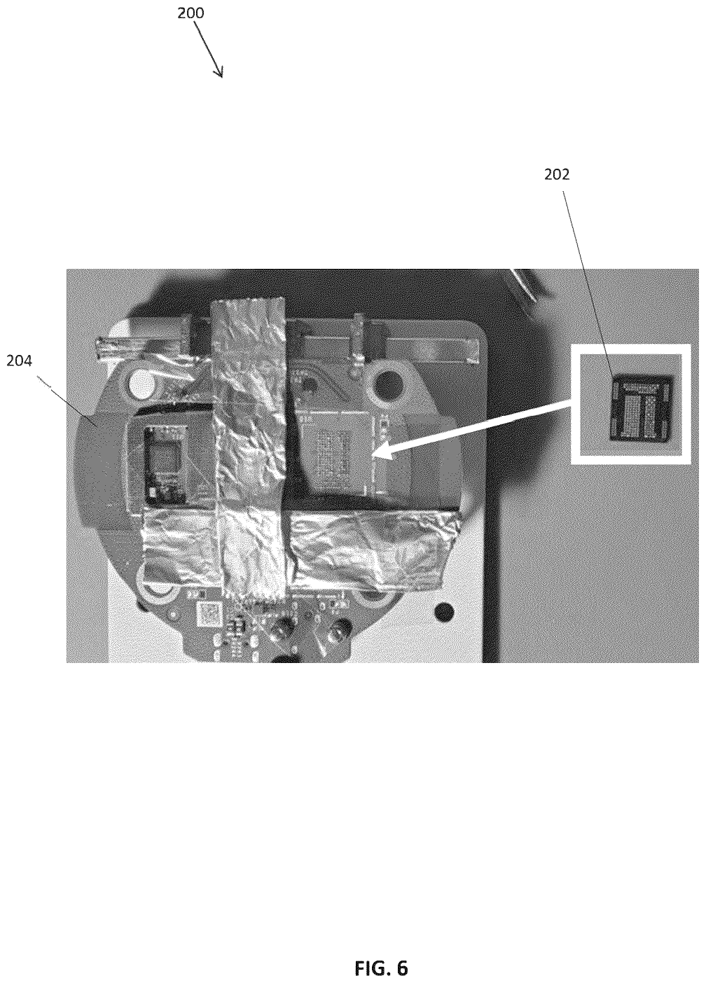

Concentrating on the memory: One main focus was on the memory chip (Micron 6PA98 JWB30, as shown in FIGS. 3 to 6) to determine a non-destructive way to extract data from it. FIG. 3 shows the inside of an IoT device 200. The IoT device 200 has a printed circuit board (PCB) 204 with chips on it. This PCB 204 has a memory chip 202 and metal shielding 205. FIG. 4 shows a portion of the metal shielding 205 which has been removed 208. FIG. 4 also shows heat resistant tape 206 used during removal of the memory chip 202 from the PCB 204. FIG. 5 shows aluminum foil 210 and heat resistant tape 206, in preparation for removal of the memory chip 202. FIG. 6 shows the memory chip 202 removed from the PCB 204

For the example of an Echo Dot 2, the chipset includes a memory chip 202 from Micron. For stand-alone devices, low power draw devices are often used such as eMMC (embedded multimedia card) and eMCP (embedded multichip packages), as also for mobile phones. Micron assigns its eMMC and eMCP chips with a Fine-pitch Ball Grid Array (FBGA) code as the last five characters of the chip's name (‘JWB30’ in this example). The webpage for the memory chip provided only basic information, but no datasheet. The exemplary chip shown is a BGA 221 eMCP that holds a 4 GB Multi-level Cell (MLC) eMMC and a 4 GB Low-Power Double Data Rate 3 (LPDDR3) Random Access Memory (RAM). Since the datasheet was not available, a chip-off on the donor (control) device may be carried out to confirm that it uses a BGA 221 ball socket System-On-Chip (SOC) eMCP.

Finding a memory reading method for ISP: JTAG (Joint Test Action Group) and UART (Universal Asynchronous Receiver Transmitter) connections need the CPU to extract data from an eMMC chip on a given board. Thus, the state of a CPU of a seized device may itself influence the ability to read out the data stored. In some instances, powering up the CPU may render the device useless from a digital forensic perspective Moreover, most device manufacturers do not disclose their JTAG and UART connection information publicly, as in the case of Echo Dot 2. Therefore, a nondestructive data reading method could be worked out if all the ISP pins (Table II), VCC, GND, VCCQ, CMD, DATO, and RST, were available. This research identified all ISP pins located on the bottom of the memory chip, which was mounted face down on the board before the chip-off analysis on the donor device was carried out (FIGS. 6-9).

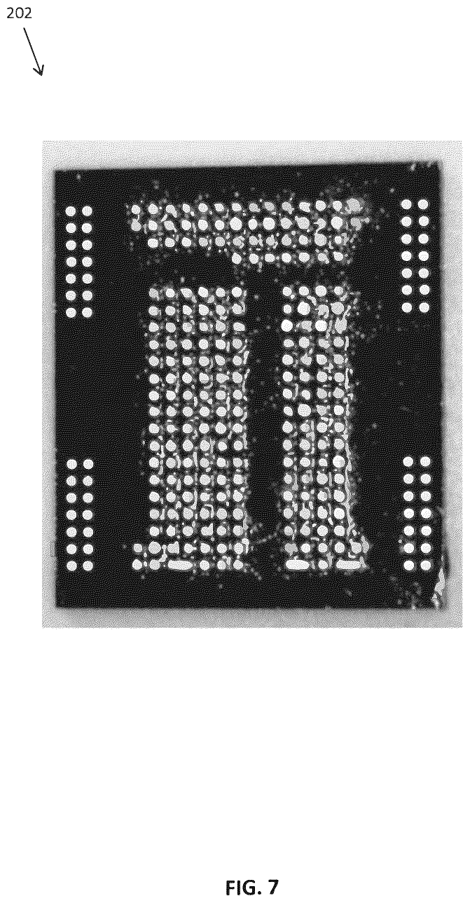

FIG. 6 illustrates an IoT device 200 with its memory chip 202 removed from the PCB 204. FIG. 7 shows the rear of the removed memory chip 202. In normal operation, the metal pins on the rear of the memory chip 202 mate to corresponding metal contacts on the PCB 204. More details are available in subsection 3.1.

TABLE II
In-System Programming (ISP) Pinout
from JEDEC Standard JESD84-B451

| Pin | Description |
|---|---|
| CMD | Clock Signal |
| CLK | Bidirectional Command Signal |
| DAT0 | Bidirectional Data Channel Zero (first out of 8 channels) |
| GND | Ground signal (VSS for Core; VSSQ for I/O) |
| VCC | Power supply for Core |
| VCCQ | Power supply for I/O (Input/Output) |
| RST | Reset |

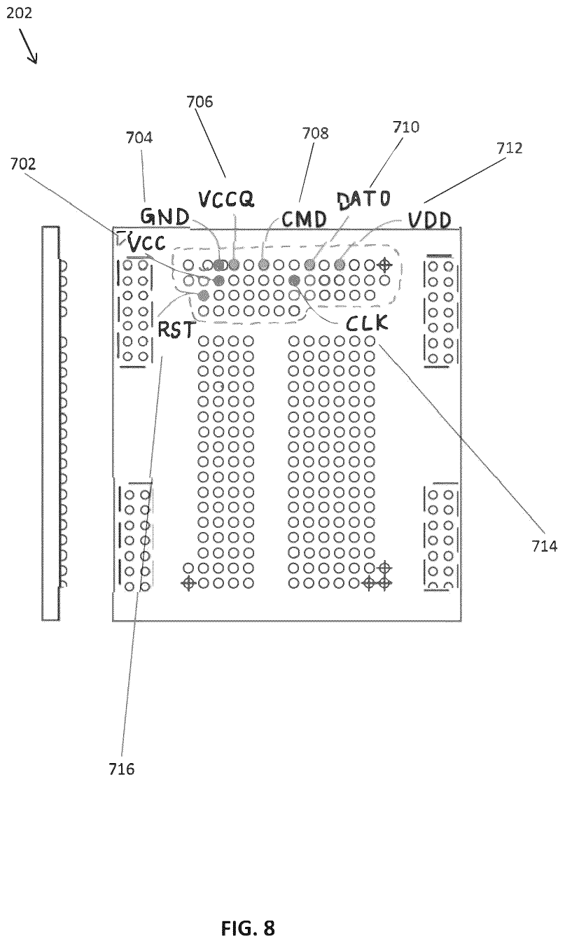

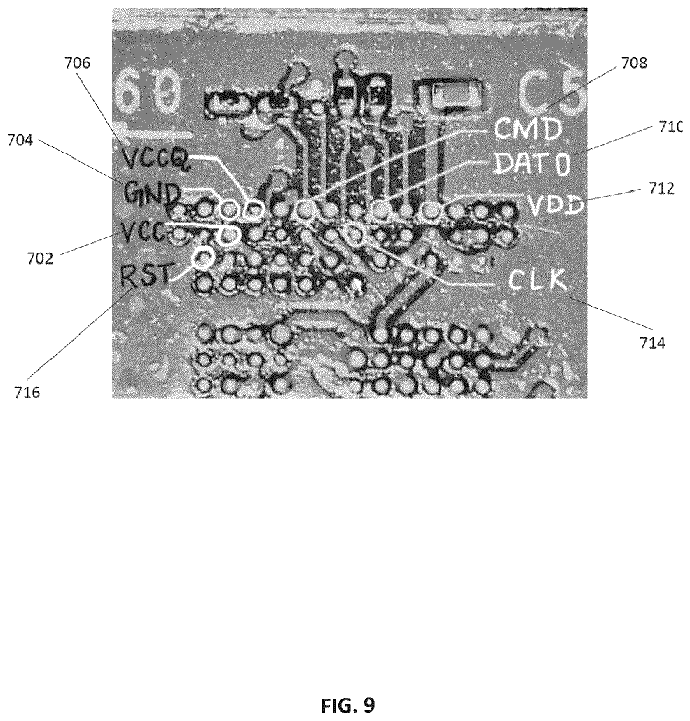

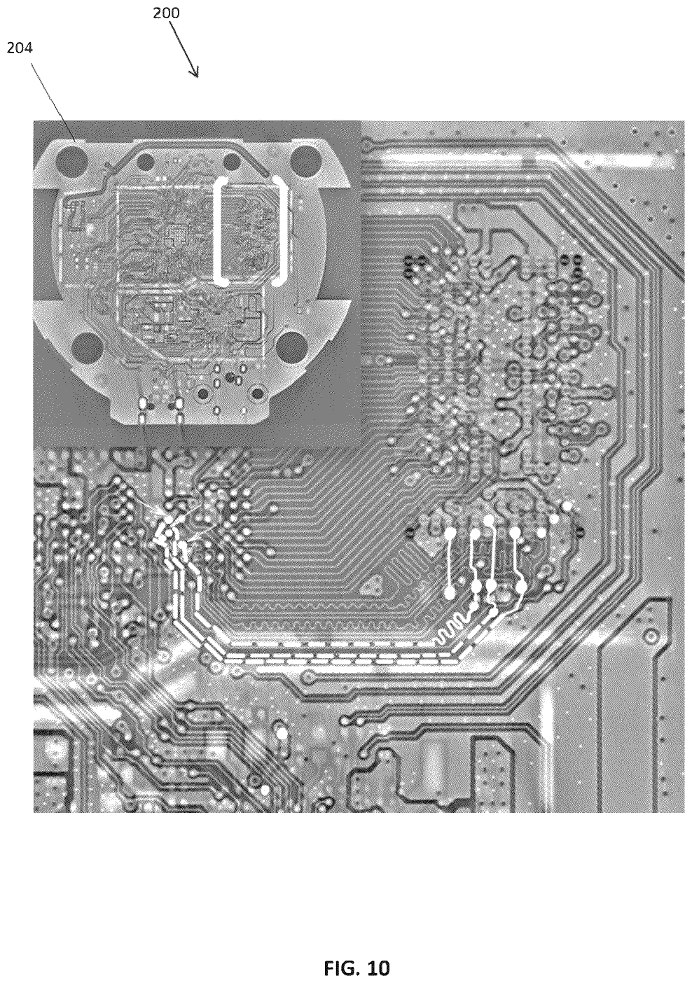

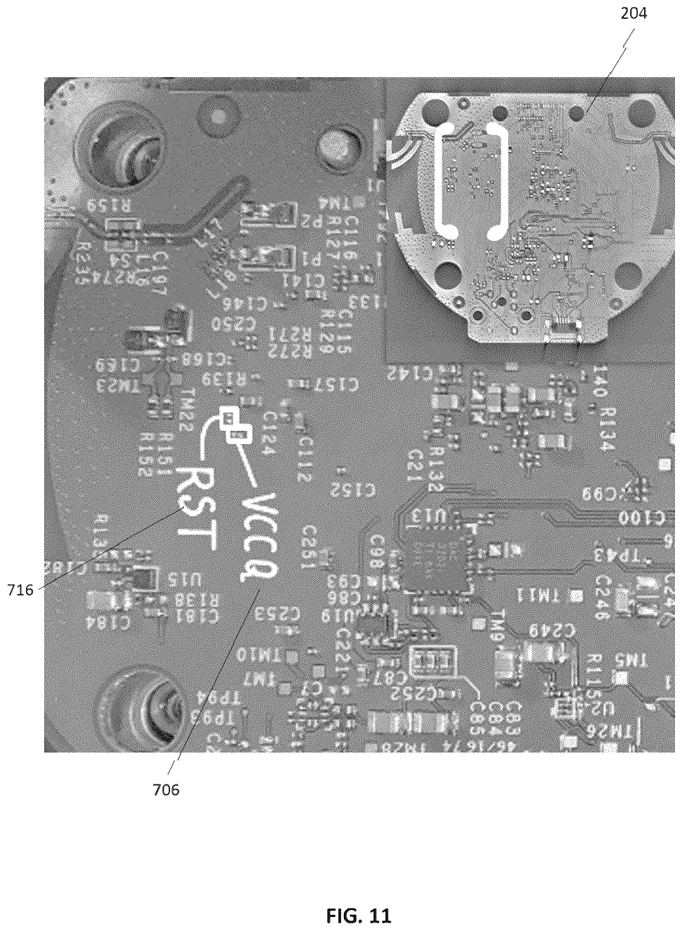

Locating the ISP pins using CT Scan: After locating the ISP pins on the memory chip, the next step is to trace connections from the Echo Dot 2's PCB that terminate on the respective ISP pins under the memory chip (FIGS. 8-11). FIG. 8 illustrates a profile view of the memory chip 202 on the left hand side of the figure. FIG. 8 also illustrates a flipped pin mapping so that the identified pins show the same relative locations as on FIG. 9, the section to which the memory chip 202 is mated on the PCB 204. (Since the top of the PCB is mated to the bottom of the memory chip, the chip will be turned over so that metal parts mate correctly.) In this example, two of the connections leading to the required ISP pins are not directly available on the PCB circuit surface. These connections are untraceable on either of the board's surfaces (top and bottom) as they travel inside the PCB board substrate. A computed tomography (CT) Scan of the Echo Dot 2 donor device's main PCB was obtained to determine the two hidden ISP pin connections from the portion of the PCB under the memory chip to two different points on the bottom of the board (FIGS. 10 and 11). FIG. 8 identifies the memory chip 202 pins on the flipped pin mapping, which are also identified in Table II. The connecting pins are also identified by element number and by abbreviation also in FIG. 9. FIG. 10 illustrates the results of a CT (X-ray) scan of the PCB 204 of the IoT device 200. The PCB in this example is the BGA 221 with the pinout region expanded. The solid white lines are contact points used for contacts as explained in the jig section below. The dashed white lines illustrate that these lines connect to the CPU or go under the CPU. The entire PCB 204 is shown in the inset, with a more detailed portion of the region in brackets, which is the location where the memory chip 202 is mounted on the PCB 204. The CT Scan is required to trace elements which are not otherwise obvious from the surface of the PCB 204. FIG. 11 shows the CT Scan results of the full PCB 204 in the inset and flipped horizontally relative to FIG. 10, with a close-up photograph of the region in brackets, including the locations of the RST 716 and VCCQ 706 contact pins on the backside/bottom of the PCB 204. More details are available in subsection 3.2.

Verifying the ISP connections: All six points available for soldering were soldered to, four on the top and two on the bottom, corresponding to the six ISP pins. An oscilloscope and logic analyzer were used to read the assumed ISP connections. After testing the connections with an oscilloscope and logic analyzer, the soldered wires were connected to an eMMC reader. The cMMC reader was used to obtain a full data dump from the memory chip. More details are available in subsection 3.3. Data extraction from an onboard memory chip using ISP connections is considered relatively nondestructive as compared to chip-off. However, the process of micro-soldering using the ISP connections makes slight modifications to the original device, and if not done correctly (by an expert), it could also damage the board. This method enables bypassing the micro-soldering step and is thus completely non-destructive.

Developing non-destructive reading mechanism—Test Probe Jig: The goal of this research was to explore and identify a genuinely non-destructive way of data extraction, which would not require micro-soldering expertise. A ‘Test Probe Jig’ may be employed that uses pogo pins (spring-loaded contact pins) mounted on a 3D printed fixture to connect and later dump data from the Echo Dot 2 memory chip. More details are available in subsection 3.4.

Obtaining the data dump: The Test Probe Jig may also be used on the evidence device. The Test Probe Jig is attached to the PCB with the pogo pins in direct contact with the ISP pin locations. The Jig is connected to the eMMC reader. The eMMC reader is connected to a computer to complete the data dump. The extraction and analysis steps that deal with the analysis of the memory dump is explained in sub-section 3.5.

The following sections provides an in-depth explanation of the same.

3.1 Finding the ISP Pins Using Chip-Off

In order to extract data from the eMCP memory chip (Micron 6PA98 JWB30, 4 GB, LPDDR3) the BGA package of the eMCP chip needed to be identified along with the ISP pin connections on the PCB. Since information about neither the BGA package nor the ISP connections used in Echo Dot 2 memory chip is available in open literature; it was necessary to remove the chip from a companion/donor device to confirm this information. The process for removing a chip already soldered to a PCB is called the chip-off procedure and its details are given below.

Together with the CPU and the wireless chip, the memory chip 202 is enclosed inside metal shielding 205. A portion of shielding around the memory chip was removed 208 to get better access to the shared space between the chip 202 and the board 204. Then the other components around the memory chip may be covered with heat resistant tape 206 and a layer of aluminum foil strips 210 for added heat protection to prevent damage to the other circuitry on the board (FIGS. 3-6). The memory chip 202 may be removed using a hot air station and that the chip may use a “BGA 221 Ball Socket SOC” as illustrated in FIGS. 7-8.

To analyze this memory chip 202, the In-System Programming (ISP) connections on the chip must be identified and connections made to them. ISP is a way to connect to eMMC and eMCP chips. The ISP connections were sought so that data could be extracted directly from the eMMC without powering on the whole board. These specific six pins were identified: VCC 702. VCCQ 706, CMD 708, CLK 714, DATO 710, and RST 716.

The BGA connections on the Echo Dot 2 board were examined to determine the above stated ISP connections. FIGS. 7-9 show the data pin connections of the board. Out of these ISP pins, four pins, namely GND 704, VCC 702, VCCQ 706, and RST 706 (those shown in the left hand side (red) of FIG. 9), are entirely covered by the memory chip while attached to the Echo Dot 2 board. FIG. 9 shows these pins among the BGA connections on the board. These four pins connect to other board components through wire connections that are not visible on the board surface. The manufacturer has embedded some traces in the board substrate that do not show on the top or bottom surfaces.

Because the traces are embedded for two of the pins, it would not be possible to access the data from the eMMC chip using ISP connection to the board. This would require chip-off methods. In order to develop a non-destructive way to access the memory chip's data, it is necessary to find the hidden ISP connections that start from these four BGA pins and end at some location on the surface of the board. Because they are not visible, a CT scan was used to identify the traces.

3.2 CT-Scan of the Echo Dot 2's Main PCB

A Computed Tomography (CT) Scan of the Echo Dot 2 board was used to find these hidden connections. Table III lists all details about the CT scan hardware and the corresponding software used. By analyzing the traces revealed in the CT scan hidden connections for VCCQ and RST BGA pins were identified. Metal shielding was used as the GND connection. The VDD pin substitutes for the VCC pin.

TABLE III
CT Scan Machine Model and Respective Software

| CT Scan Machine | Software |
|---|---|
| NSI X3000 with PerkinElmer 1611 detector | efX-CT v2.1.8.0 |
| NSI X5000 with Varian 4343 detector | efX-CT v2.1.8.0 |

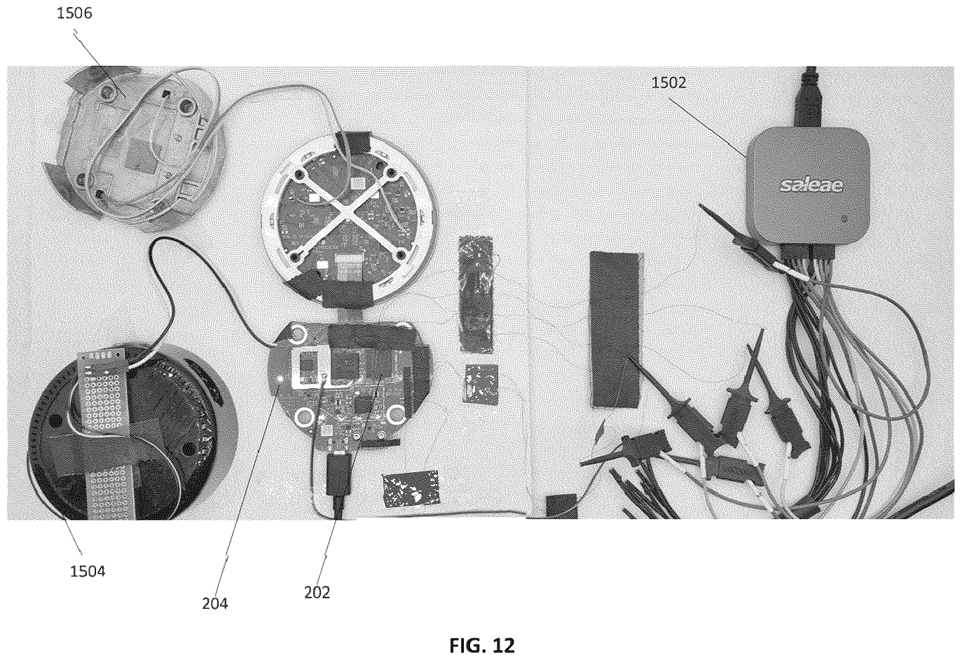

3.2.1 Logic Analyzer: Once a connection was established to all the ISP pins a logic analyzer was used to check the signal data of the ISP connection (FIG. 12). The above stated method cross-compares the BGA 221 pinout sheet from section 3.1 and the CT-Scan images. The logic analyzer was also used to verify the individual pin voltages of recently identified ISP pins. The valid range for VCC and VCCQ are shown in Table IV.

TABLE IV
eMMC Voltage combinations (JEDEC standard JESD84-B451)

| | | VCCQ | | |
|---|---|---|---|---|
| | | 1.1 V-1.3 V | 1.70 V-1.95 V | 2.7 V-3.6 V |
| VCC | 2.7 V-3.6 V | Valid | Valid | Valid* |
| | 1.7 V-1.95 V | Valid | Valid | Not Valid |

*VCCQ (I/O) 3.3 Volt range is not supported in HS200 devices (operating frequency between 52 MHz and 200 MHz)

3.3 ISP Data-Dump

An attempt to download all the data from the chip using the ISP connections was made through an eMMC reader. All the ISP pins were micro-soldered and connected to the computer using an eMMC reader.

3.3.1 Reading as SD card: The eMMC memory uses MMC (abbreviation for MultiMedia Card), a type of embedded flash memory like an SD card, and follows a similar communication protocol.

An eMMC reader connected the corresponding wires to the reader may be used to pull data (as a binary file).

In an embodiment, additional tools like Binwalk, 7-Zip, PowerISO, and Magic ISO to inspect and extract the file system partitions from the dumped binary final. Binwalk and 7-Zip are open source tools, whereas Magic ISO and Power ISO are shareware.

3.4 Test Probe Jig Development

The main PCB board's dimensions were measured using a digital vernier caliper. The dimensions were converted from a top-view image of the PCB board to the Scalable Vector Graphic (SVG) format. The image's measurements were verified with the caliper's readings before importing the SVG file to make an STL file for a 3D printer. STL (an abbreviation for STereoLithography) is a file format used to print on 3D printers.

In an embodiment, design software such as Autodesk's Tinkercad and Fusion 360 may be used to create a rapid prototype of a Test Probe Jig. In the example shown, an initial jig design was made in Tinkercad, but a final design used the Fusion 360 software for further refinement before making the final 3D print.

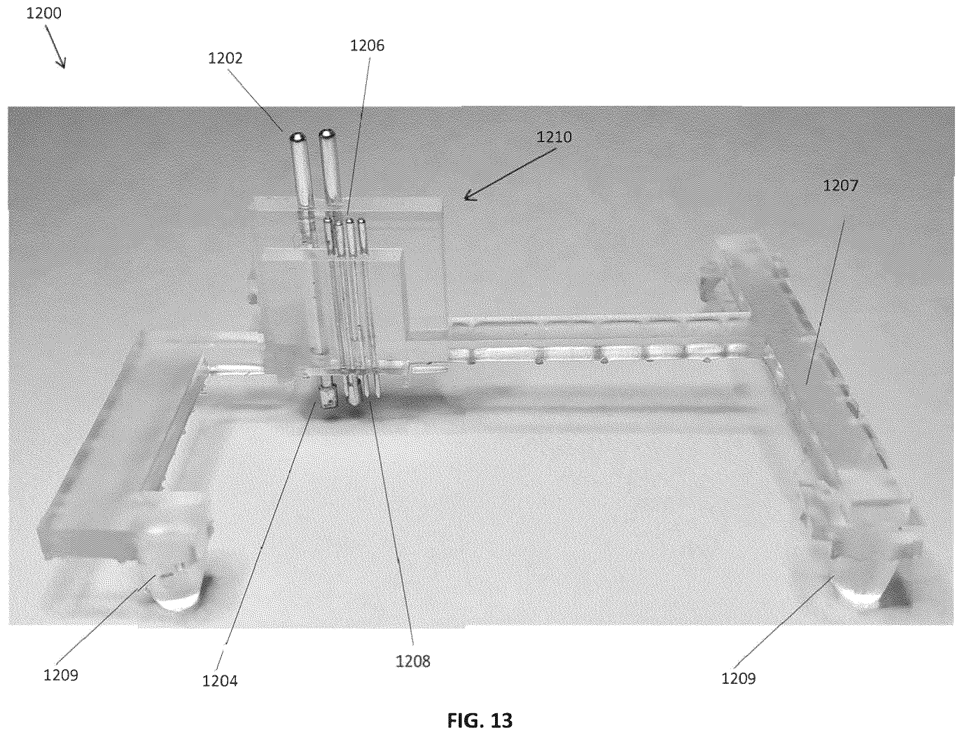

Any 3D printer may be used to create a test probe jig. In an example embodiment, A Stercolithography (SLA) Liquid 3D Printer (Elegoo Mars) may be used to print the Test Probe Jig, as shown in FIGS. 13-16. In this example, a resin is used to create a Test Probe Jig 1200. The Test Probe Jig 1200 may have a body with arms 1207 and feet 1209 for stability and to leave space for the PCB 204. Pogo pins 1202, 1206 may be held together in a designated portion 1210 of the Test Probe Jig 1200. The probe pins 1202 may have spring-loaded contact sections 1204, 1208 to control the force of contact on the PCB. A resin may be used to connect with the pre-identified ISP points on the PCB. Some of the probe pins may be large diameter pins 1202, with large diameter contact sections 1204. Some of the probe pins may be small diameter pins 1206 with small diameter contact sections 1208. The Test Probe Jig 1200 may connect the probe pins 1202, 1206 to contact portions of the PCB. These connections may enable reading the memory chip by connecting to it with, for instance a specialized chip reader 1502 such as an EasyJTAG or a RIFF Box eMMC tool.

3.5 Data Dump and Processing

All the data from the Echo Dot 2's memory was downloaded as a binary file. The extracted data includes filesystem partitions used by the Echo Dot 2. Further details about the filesystem partitions are discussed below.

### Example

The Test Probe Jig 1200 for the exemplary Echo Dot 2 was connected with an eMMC reader and then to a computer. ISP can interact directly with the eMMC chip bypassing the need to use the CPU to read the chip's data. From a forensic perspective, it is important to ensure that the state of the digital device is preserved.

If the device is turned on accidentally, a substantial amount of data changes in the storage unit, as the CPU and the operating system will start making changes to several files. In other words, once a digital device is seized for investigation in a turned-off state, the investigators must not turn it on; otherwise, the seized device may not be considered admissible evidence in a court of law.

The ISP pins used by the Test Probe Jig could directly connect to the onboard eMMC chip and dump the data without starting the CPU or other components on the Echo Dot 2's PCB. This capability of the Test Probe Jig is similar to professional digital forensic tools and ensures that the Echo Dot 2's data dump is a forensically safe process.

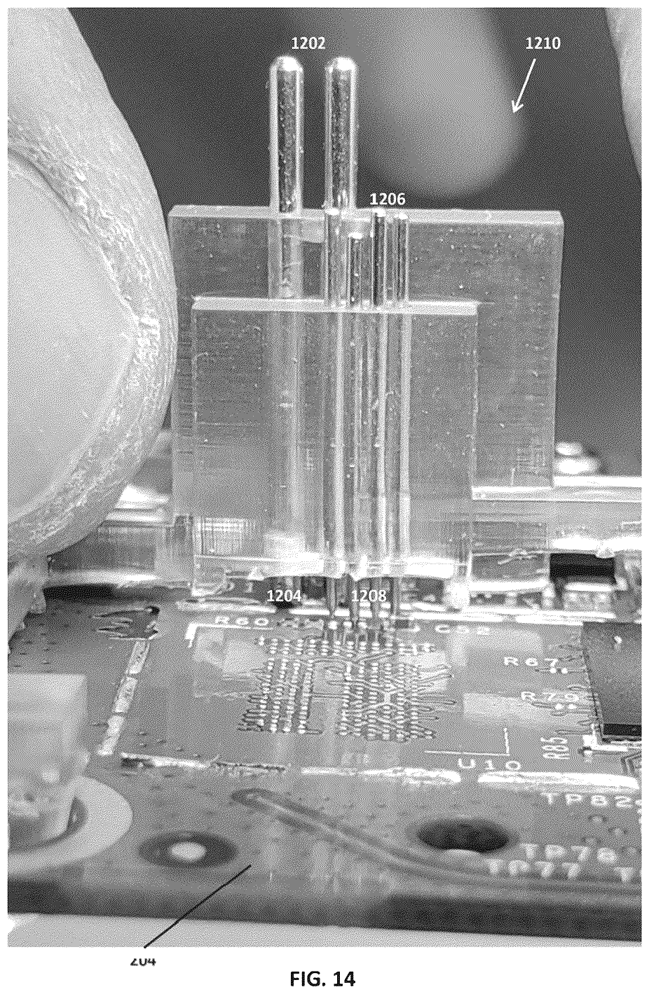

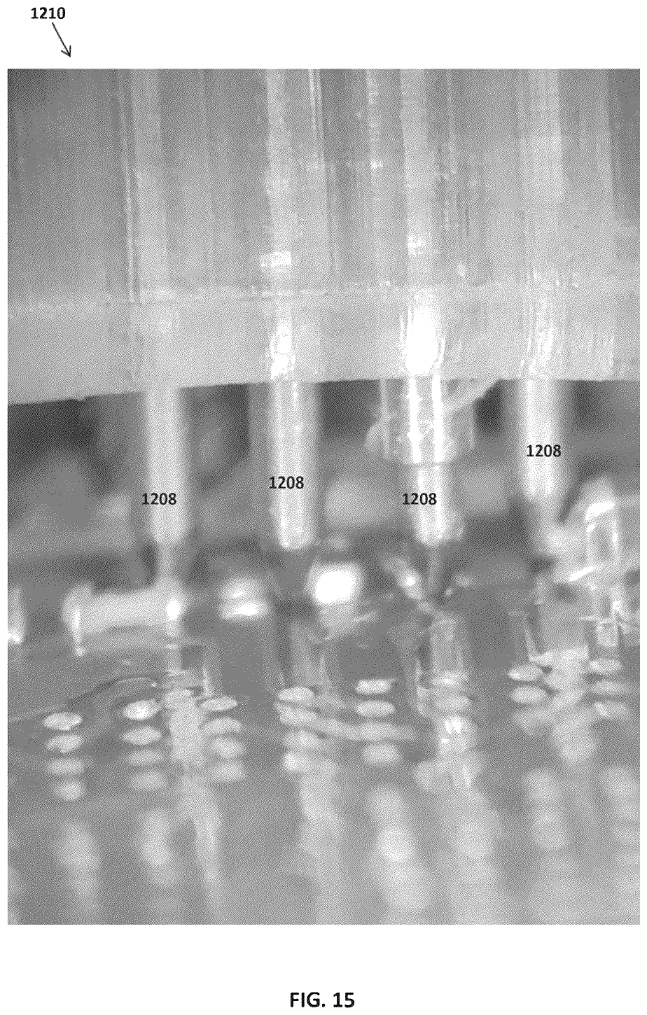

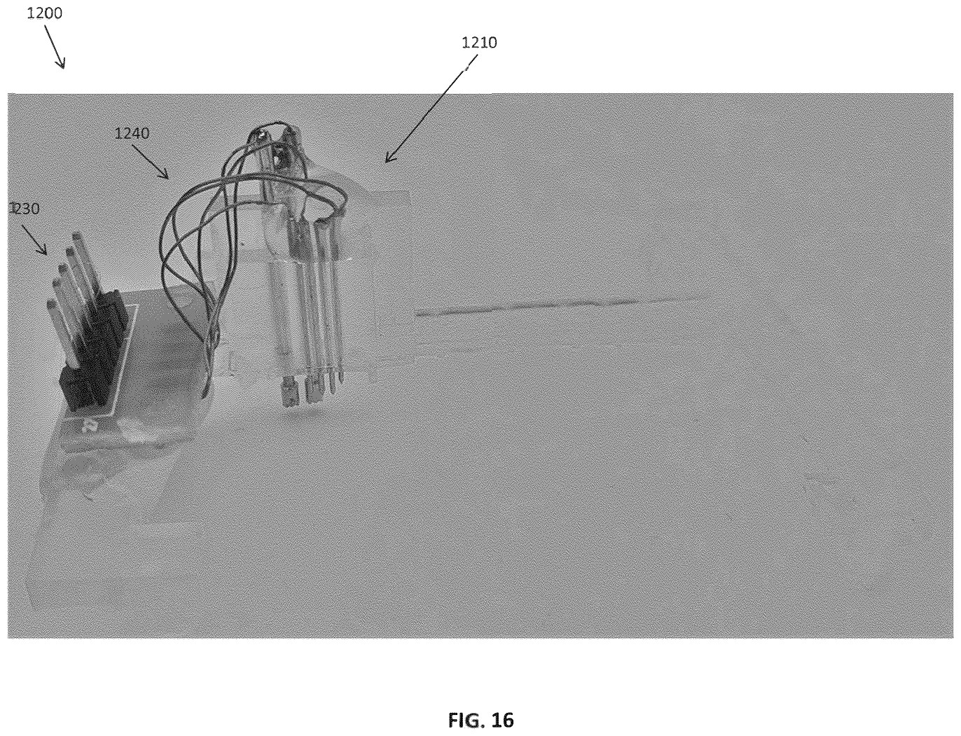

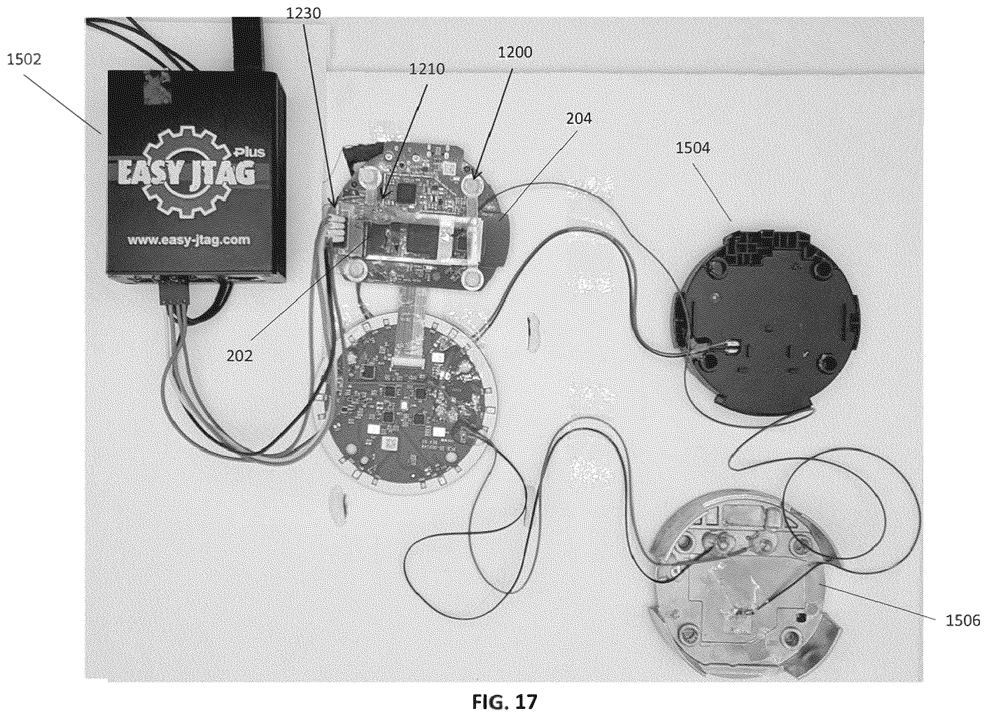

In an embodiment, multiple sets of pogo pins may be used, as required to mate properly to the PCB or the memory chip. For example, FIG. 13 shows four P50-B1 pogo pins (tip of 0.48 mm, and length of 16 mm, small pogo pints 1206) in the front of the designated pin portion 1210 of the Test Probe Jig 1200, as well as two P60H pogo pins (tip of 1.5 mm, and length of 24 mm, large pogo pins 1202) in the rear of the designated pin portion 1210. FIGS. 14-15 show more closely the large pins 1202 and the small pines 1206, though other pins might also be used, of a variety of geometries. FIG. 16 illustrates how thin soldering wires 1240 may be used to connect these pogo pins 1202, 1206 to a port 1230, from which they can be further connected to an eMMC reader 1502 (e.g. EasyJTAG) or to a port 1230 which can be connected to such a reader, as shown in FIGS. 16-17. A metal reinforcement layer 1506 and a plastic housing 1504 are also shown for the IoT device 200

The resistance of the connecting wires (between the pogo pins and the eMMC reader) should be as low as possible to avoid any potential voltage drops. The length of the wire should be as small as possible for a given width (diameter). The resistance of these connecting wires plays a crucial role in ensuring a successful data dump using the Test Probe Jig 1200. In alternative embodiments, wires with different diameters may be used for connecting the pogo pins 1202, 1206 to the electronic reader 1502 (e.g. EasyJTAG as in FIG. 17 or a Saleae in FIG. 12). An exemplary Test Probe Jig 1200 may use wires with, for instance, a resistance of 0.083 Ohms, and a diameter of 36 AWG (0.127 mm diameter). An exemplary length of such a wire may be 50.8 mm. Such wires may be used to connect to the proper pins of the memory chip 202 and so obtain a data dump of the memory chip 202. Once a jig and wires are ready, the respective voltages may be measured on all the pogo pins, an example of which is presented in the table below (Table V).

TABLE V
Voltages observed at Test Probe Jig’s pins when the jig
is fixed on an Echo Dot 2’s main PCB as shown in FIG. 17.

| Signal | Observed Voltage |
|---|---|
| VCC | 3.30 |
| VCCQ | 1.80 |
| CLK | 1.78 |
| DAT0 | 0.90 |
| CMD | 1.77 |

Verification of the Extracted Firmware

In an embodiment, Echo Dot 2's firmware (a binary file) residing in the eMMC chip may be extracted using the Test Probe Jig 1200 along with a chip reader 1502. In another embodiment a tool called “Test Probe Wafer Station” may also be used to acquire the firmware of the same device.

The extracted firmware dump from the Test Probe Jig 1200 is then compared with the binary file obtained from the micro soldered ISP pins (section 3.3). A chipoff on the companion/donor device may then extract the firmware and the results may be compared with the previous two cases. The comparison process is helpful to verify that the firmware dumps obtained from the test probe jig method, the micro-soldering method, and the chip-off method are identical. The SHA1 hashes of all partitions contained in the firmware obtained in these three cases match (Table VI). Additionally, the partition hashes from these three cases also match with corresponding partitions obtained using the Test Probe Wafer station (Table VII). This verification proves that the firmware read from an Echo Dot 2 device using the test probe jig 1200 produces same results when using microsoldering, chip-off, or the professional grade Test Probe Wafer Station.

TABLE VI
SHA1 hashes of all partitions inside Echo Dot 2’s
firmware, extracted using three different methods

| Partition | | | |
|---|---|---|---|
| Name | Test Probe Jig | Micro-Soldering | Chip-off |
| kb.img | abb49fa42b4d0d772ddeee | abb49fa42b4d0d772ddeee | abb49fa42b4d0d772ddeee |
| | 85dacbc873ef072b68 | 85dacbc873ef072b68 | 85dacbc873ef072b68 |
| dkb.img | efd77635683a19e3701788 | efd77635683a19e3701788 | efd77635683a19e3701788 |
| | 42437e84b95171b792 | 42437e84b95171b792 | 42437e84b95171b792 |
| lk_a.img | 0e2df990d50838a43909b5 | 0e2df990d50838a43909b5 | 0e2df990d50838a43909b5 |
| | 063a1a4537c87d1b28 | 063a1a4537c87d1b28 | 063a1a4537c87d1b28 |
| tee1.img | 5360d863883180ed359af3 | 5360d863883180ed359af3 | 5360d863883180ed359af3 |
| | b8ec3c219eb47f1a94 | b8ec3c219eb47f1a94 | b8ec3c219eb47f1a94 |
| lk_b.img | 0e2df990d50838a43909b5 | 0e2df990d50838a43909b5 | 0e2df990d50838a43909b5 |
| | 063a1a4537c87d1b28 | 063a1a4537c87d1b28 | 063a1a4537c87d1b28 |
| tee2.img | 5360d863883180ed359af3 | 5360d863883180ed359af3 | 5360d863883180ed359af3 |
| | b8ec3c219eb47f1a94 | b8ec3c219eb47f1a94 | b8ec3c219eb47f1a94 |
| expdb.img | 8c206a1a87599f532ce686 | 8c206a1a87599f532ce686 | 8c206a1a87599f532ce686 |
| | 75536f0b1546900d7a | 75536f0b1546900d7a | 75536f0b1546900d7a |
| misc.img | 1904ddb1feb2f16d9ce692 | 1904ddb1feb2f16d9ce692 | 1904ddb1feb2f16d9ce692 |
| | 36cf859485614193bc | 36cf859485614193bc | 36cf859485614193bc |
| persist.img | 3b4417fc421cee30a9ad0f | 3b4417fc421cee30a9ad0f | 3b4417fc421cee30a9ad0f |
| | d9319220a8dae32da2 | d9319220a8dae32da2 | d9319220a8dae32da2 |
| boot_a.img | 3372a7e8271a2235564a8 | 3372a7e8271a2235564a8 | 3372a7e8271a2235564a8 |
| | 906d8ea92b4c1c53f7b | 906d8ea92b4c1c53f7b | 906d8ea92b4c1c53f7b |
| boot_b.img | 3372a7e8271a2235564a8 | 3372a7e8271a2235564a8 | 3372a7e8271a2235564a8 |
| | 906d8ea92b4c1c53f7b | 906d8ea92b4c1c53f7b | 906d8ea92b4c1c53f7b |
| recovery.img | 6fe87320edc55c6382b755 | 6fe87320edc55c6382b755 | 6fe87320edc55c6382b755 |
| | 8857dff49f6685c527 | 8857dff49f6685c527 | 8857dff49f6685c527 |
| system_a.img | c6d8411f98e94d13537fb3 | c6d8411f98e94d13537fb3 | c6d8411f98e94d13537fb3 |
| | dd1635b915ce51bcfd | dd1635b915ce51bcfd | dd1635b915ce51bcfd |
| system_b.img | c6d8411f98e94d13537fb3 | c6d8411f98e94d13537fb3 | c6d8411f98e94d13537fb3 |
| | dd1635b915ce51bcfd | dd1635b915ce51bcfd | dd1635b915ce51bcfd |
| cache.img | 2ab18a3823b3a561b7055 | 2ab18a3823b3a561b7055 | 2ab18a3823b3a561b7055 |
| | eaf5c08404eaa70b725 | eaf5c08404eaa70b725 | eaf5c08404eaa70b725 |
| userdata.img | b7cf9dc702d5c157555159 | b7cf9dc702d5c157555159 | b7cf9dc702d5c157555159 |
| | 5154dbee903f4133e1 | 5154dbee903f4133e1 | 5154dbee903f4133e1 |

TABLE VII
SHA1 hashes partitions inside the firmware
obtained using Test Probe Wafer Station.

| Partition Name | Test Probe Wafer Station |
|---|---|
| kb.img | abb49fa42b4d0d772ddeee85dacbc873ef072b68 |
| dkb.img | efd77635683a19e370178842437e84b95171b792 |
| lk_a.img | 0e2df990d50838a43909b5063a1a4537c87d1b28 |
| tee1.img | 5360d863883180ed359af3b8ec3c219eb47f1a94 |
| lk_b.img | 0e2df990d50838a43909b5063a1a4537c87d1b28 |
| tee2.img | 5360d863883180ed359af3b8ec3c219eb47f1a94 |
| expdb.img | 8c206a1a87599f532ce68675536f0b1546900d7a |
| misc.img | 1904ddb1feb2f16d9ce69236cf859485614193bc |
| persist.img | 3b4417fc421cee30a9ad0fd9319220a8dae32da2 |
| boot_a.img | 3372a7e8271a2235564a8906d8ea92b4c1c53f7b |
| boot_b.img | 3372a7e8271a2235564a8906d8ea92b4c1c53f7b |
| recovery.img | 6fe87320edc55c6382b7558857dff49f6685c527 |
| system_a.img | c6d8411f98e94d13537fb3dd1635b915ce51bcfd |
| system_b.img | c6d8411f98e94d13537fb3dd1635b915ce51bcfd |
| cache.img | 2ab18a3823b3a561b7055eaf5c08404eaa70b725 |
| userdata.img | b7cf9dc702d5c1575551595154dbee903f4133e1 |

### Exemplary Results

In an example, data may be extracted data from more than one Echo Dot version 2 device. In an example, one device is referred to as the “baseline” or “new” device which contained no user data. A second device was previously used (hereafter referred to as a “used” device) and had been factory reset and resold from eBay as a “used and reset” device. The factory reset process was run again, but the device still contained some user data. The two separate data dumps from each of these devices were used for analysis and comparison. ‘Binwalk’ may be used on these respective binary files (from the new and the used Echo Dot 2) to examine their filesystem partitions.

The above stated binaries were uncompressed into 25 ‘ext4’ partitions, out of which there are 9 unallocated spaces with sizes ranging from 33 to 32768 sectors (or 16.5 KB to 16.0 MB). The sizes for the rest of the 16 partitions are shown in Table VIII. These 9 unallocated partitions are not present in the binary image of Alexa Pi (Echo Dot 2's firmware emulated on Raspberry Pi).

TABLE VIII
Partitions obtained from the Echo Dot 2’s binary file (GPT header)

| S. No | Partition | Offset | Size | |
|---|---|---|---|---|
| 1 | kb | 000000100000-000000200000 | 1.00 | MB |
| 2 | dkd | 000000200000-000000300000 | 1.00 | MB |
| 3 | lk_a | 000001000000-000001100000 | 1.00 | MB |
| 4 | tee1 | 000001800000-000001D00000 | 5.00 | MB |
| 5 | lk_b | 000002000000-000002100000 | 1.00 | MB |
| 6 | tee2 | 000002800000-000002D00000 | 5.00 | MB |
| 7 | expdb | 000003000000-000003A00000 | 10.00 | MB |
| 8 | misc | 000003A00000-000003A80200 | 512.00 | KB |
| 9 | persist | 000004000000-000005000000 | 16.00 | MB |
| 10 | boot_a | 000005000000-000006000000 | 16.00 | MB |
| 11 | boot_b | 000006000000-000007000000 | 16.00 | MB |
| 12 | recover | 000007000000-000008000000 | 16.00 | MB |
| 13 | system_a | 000009000000-000039000000 | 768.00 | MB |
| 14 | system_b | 000039000000-000069000000 | 768.00 | MB |
| 15 | cache | 000069000000-00009A000000 | 784.00 | MB |
| 16 | userdata | 00009A000000-0000E8FFBE00 | 1.23 | GB |

The last 4 partitions, namely system a, system b, cache, and userdata, contain most of the forensically relevant data. In an example, ‘Autopsy’ software may be used as a digital forensic tools, to process the above stated binary files and the partitions inside them.

The current work presents some key forensic artifacts obtained from the used Echo Dot 2 device. A fresh Echo Dot 2's binary dump was analyzed and the results may be compared with those of the used device. All the exemplary results discussed below are from the used Echo Dot 2, unless specifically mentioned as having been obtained from the baseline device.

The potentially relevant forensic information available on the Echo Dot 2 is presented in Table IX. Information related to WiFi connections was found including paired Bluetooth devices, unique identifiers, software versions, SQLite 3 databases, and logs.

TABLE IX
Forensically relevant information inside Echo Dot 2's partitions

| Category | Information | Address on Partition |
|---|---|---|
| WiFi | SSID | userdata/misc/wifi/wpa supplicant.conf |
| | | userdata/misc/wifi/wpa supplicant.conf.tmp* |
| | DHCP | userdata/misc/dhcp/dnsmasq.leases |
| Bluetooth | MAC Addr. | userdata/misc/bluedroid/bt config.xml |
| | | userdata/misc/bluedroid/bt config.old |
| | MAC Addr. of | userdata/local/whad/btdevice.db.json; OR |
| | Supported | userdata/data/com.android.whad/btdevice.db.json |
| | Speakers | |
| Identifiers | Account | userdata/data/com.amazon.client.metrics/shared pref/account change |
| | | observer.xml |
| | | Userdata/data/com/amazon.imp/shared prefs/account change |
| | | observer.xml.bak* |
| | Customer; Device | userdata/data/com.amazon.client.metrics/shared |
| | Serial; Session ID | pref/com.amazon.client.metrics.xml |
| | Keys | |
| | Various IDS | userdata/data/com.amazon.kindleautomatictimezone/shared |
| | | pref/SSOInfo.xml.bak, OR |
| | | userdata/data/com.amazon.device.authutils/shared |
| | | pref/SSInfo.config.xml.bak* |
| Software | OS, Package list, | userdata/system/packages.list |
| Info | Package usage | userdata/system/packages.xml |
| | | userdata/system/package usage.list |
| | GUID | userdata/local/system/guid |
| Databases | Timestamps of | userddata/vitals/vitals.db |
| | System Activities | |
| | Published and | userdata/data/com.amazon.device.software.ota/databases/updates.db |
| | Pending Updates | |
| | Downloads | usersdata/data/com.amazon.providers.downloads/databases/downloads.db |
| | System, Global, | userdata/data/com.android.providers.settings/databases/settings.db |
| | and Secure | |
| | settings | |
| | App Setting | userdata/local/appreg.db |
| | Variables | system a/etc/labdictionary/.dcp.db |
| | | system b/etc/labdictionary/.dcp.db |
| Text Files | Network | userdata/misc/wifi/networkHistory.txt |
| | Logs with | userdata/logd/Log.amazon main@<UNIX Timestamp till |
| | timestamps in | miliseconds>.txt.zip |
| | name | userdata/system/dropbox/Log.amazon main#<3 or 4 digit number>@<UNIX |
| | | Timestamp till miliseconds>.txt.zip (*) |
| | | userdata/logd/Log.kernel@<UNIX Timestamp till miliseconds>.txt.zip |
| | | userdata/system/dropbox/Log.kernel#<3 or 4 digit number>@<UNIX |
| | | Timestamp till miliseconds>.txt.zip (*) |
| | | userdata/logd/Log.main@<UNIX Timestamp till miliseconds>.txt.zip |
| | | userdata/system/dropbox/Log.main#<3 or 4 digit number>@<UNIX |
| | | Timestamp till miliseconds>.txt.zip (*) |
| | | userdata/logd/Log.metrics@<UNIX Timestamp till miliseconds>.txt.zip |
| | | userdata/system/dropbox/Log.metrics#<3 or 4 digit number>@<UNIX |
| | | Timestamp till miliseconds>.txt.zip (*) |
| | | userdata/logd/Log.system@<UNIX Timestamp till miliseconds>.txt.zip |
| | | userdata/system/dropbox/Log.system#<3 or 4 digit number>@<UNIX |
| | | Timestamp till miliseconds>.txt.zip (*) |
| | | userdata/logd/Log.radio@<UNIX Timestamp till miliseconds>.txt.zip |
| | | userdata/system/dropbox/Log.radio#<3 or 4 digit number>@<UNIX |
| | | Timestamp till miliseconds>.txt.zip (*) |
| | | userdata/logd/Log.vitals@<UNIX Timestamp till miliseconds>.txt.zip |
| | | userdata/system/dropbox/Log.vitals#<3 or 4 digit number>@<UNIX |
| | | Timestamp till miliseconds>.txt.zip (*) |
| | System Events | userdata/system/dropbox/SYSTEM LAST KMSG#<3 or 4 digit |
| | | number>@<UNIX Timestamp till miliseconds |
| | | >.txt.gz (*) |
| | | userdata/system/dropbox/system app crash#<3 or 4 digit number>@<UNIX |
| | | Timestamp till miliseconds>.txt.gz (*) |
| | | userdata/system/dropbox/SYSTEM AUDIT#<3 or 4 digit number>@<UNIX |
| | | Timestamp till miliseconds>.txt (*) |
| | | userdata/system/dropbox/SYSTEM BOOT#<3 or 4 digit number>@<UNIX |
| | | Timestamp till miliseconds>.txt (*) |
| | | userdata/system/dropbox/SYSTEM RECOVERY LOG#<3 or 4 digit |
| | | number>@<UNIX Timestamp till miliseconds |
| | | >.txt (*) |
| | | userdata/system/dropbox/system app wtf#<3 or 4 digit number>@<UNIX |
| | | Timestamp till miliseconds>.txt (*) |
| | | userdata/system/dropbox/traces commonlog.txt |
| | | userdata/system/dropbox/drop112.tmp |

*Deleted files;
(*) Active as well as Deleted files

This example did not find any user audio recordings of the user's interaction with the Alexa smart assistant inside the partitions. However, the current information obtained on the Echo Dot 2's memory chip could help a digital forensic examiner to answer important investigative questions related to the device. All queries related to unique identifiers used by Echo, Wi-Fi networks, connected Bluetooth devices, system and installed app information, firmware updates, and system logs can be answered using the Echo Dot 2 device's eMMC dump.

Discussion

The current work's contribution demonstrates a nondestructive method to extract data from an IoT device 200 (Amazon Echo-Dot version 2 being an example) using a test probe jig 1200, which could help in digital forensics and cybersecurity operations. The data dump from the eMMC may help in the digital forensic investigation of a given IoT device. This non-destructive data extraction technique can be replicated by downloading the Test Probe Jig's STL file that can be printed on an appropriate 3D printer by other investigators. Cybersecurity experts could use the proposed method to take out the firmware of an infected Echo Dot 2 and examine extracted malware or for other digital forensic analysis. The cybersecurity analysts could carry out vulnerability analysis of firmware version-updates of the Echo Dot 2 (if the OEM firmware updates are not publicly available). A variety of use cases could be thought of that require researchers and practitioners to read, write, or update an IoT device's firmware without making any physical changes to the device. The hidden RST pin, discovered during CT Scan, is not used for dumping firmware binary from the eMMC; however, it could be instrumental in programming the chip (i.e., for write operations) to help cybersecurity-related tasks mentioned above. CT scans are common amongst hardware engineers and professional factories, but the audience of interest is the typical/commonly trained digital forensic examiner. The value of this approach is that one team/entity with this knowledge and access to (or ability to outsource) the CT scanner, can create a one-time design the test probe jig 1200 that the commonly trained digital forensic examiner can then repeatedly create and use without special equipment or training.

A 3D model of the test probe jig 1200 was created, where generic pogo pins 1202, 1206 are fixed on precalculated positions. The pogo pins 1202, 1206 touch specific pinouts/taps on the Echo Dot 2 main PCB. These pinouts/taps are the basic In-System Programming (ISP) pins that could interact with the onboard eMMC chip 202 without depending on the CPU as an intermediary. The pogo pins 1202, 1206 on the test probe jig 1200 could interface with an eMMC reader 1502 on the other side and enable read and write operations on the memory chip 202. During the experiments with the test probe jig 1200, it was observed that the CPU does not get switched on. Therefore, the voltages applied to these ISP taps by the test probe jig 1200 may not damage components on the PCB 204. Multiple tests were conducted on different devices and have had consistent results without damaging the CPU or other PCB components. In addition, the device powered on normally after the experiments. The proposed solution is non-destructive, easily reproducible, portable, and affordable. The same procedure described in this disclosure could be applied to other IoT devices 200 or computer devices that use eMMC/eMCP chips 202 for firmware and user data storage to create a customized test probe jig 1200 for the new device 200. The 3D model of the test probe jig 1200 could be shared with known security and law enforcement agencies to print their own copy of the jig.

This method does not depend on the FCC ID information of the given IoT device 200. Interested researchers/practitioners can perform a chip-off on the donor device to learn the respective BGA pinout. Then, the working voltages of individual ISP pins can be checked using a logic analyzer, chip reader, or multimeter. Secondly, it does not depend on the test points that may be hidden on the main PCB 204. Researchers/practitioners could use the ISP pins instead that allow them to read the memory chip 202.

Lastly, this method does not require JTAG or UART connections. JTAG and UART connections need to run the CPU to extract data from an eMMC chip on a given board. Thus, the CPU will change the state of a seized device from the digital forensic perspective. Moreover, most device manufacturers do not disclose their JTAG and UART connections information publicly, as in the case of Echo Dot 2.

The proposed non-destructive solution will work on a majority of devices, but there may be some exceptions. One of these exceptions would be where the necessary communication pins are intentionally hidden. These traces travel within the PCB substrate and do not have any tap on the surface. A CT-Scan will reveal the wiring inside the substrate; however, the pogo pins 1202, 1206 used in the test probe jig 1200, under those circumstances, would not be able to make contact without causing physical changes to the board. Another exception may occur when a chip designer has used sealing material (like epoxy) to cover all surface taps originating or ending on the eMMC chip 202. The test probe jig 1200 could work after the sealing material or epoxy is removed from the PCB as suggested by Heckmann et al. (2019). Yet another exception may occur when the device manufacturer uses a non-standard memory chip for which the ISP pinout information is not publicly available. While the example version of the test probe jig 1200 does not access the reset pin, in another embodiment, a specially designed can access the reset pin, even though the reset pin is located on the underside of the circuit board.

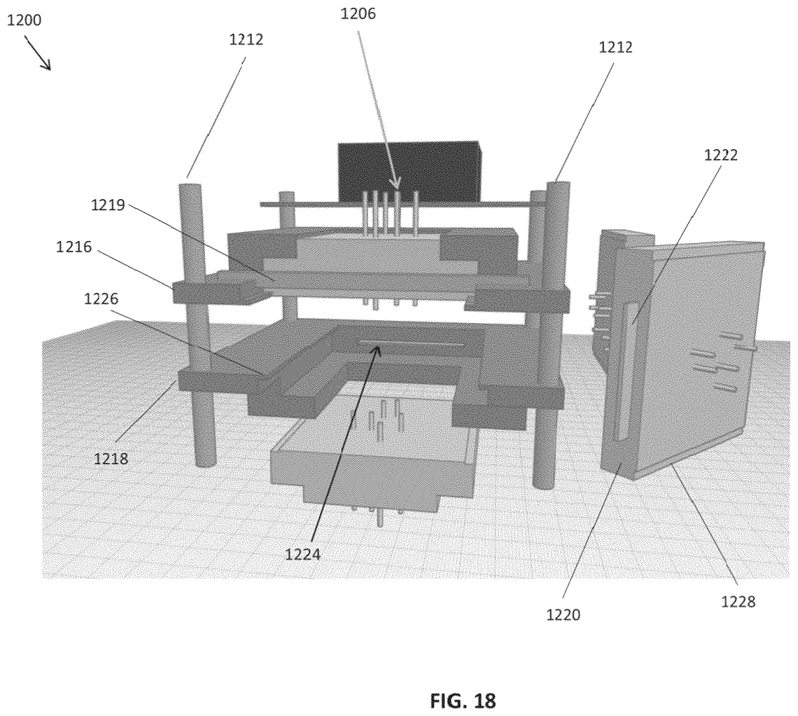

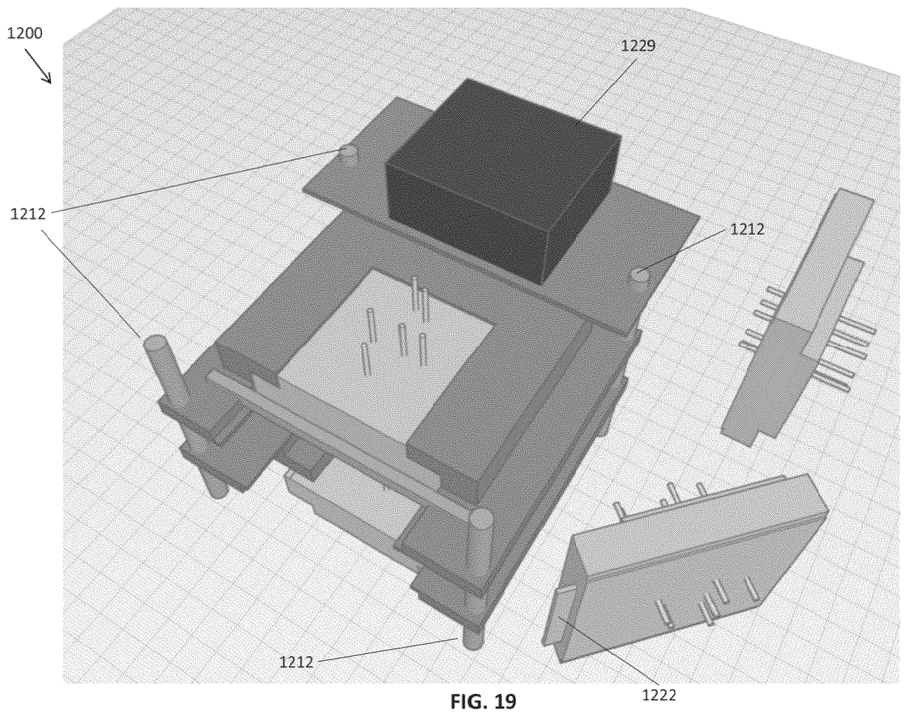

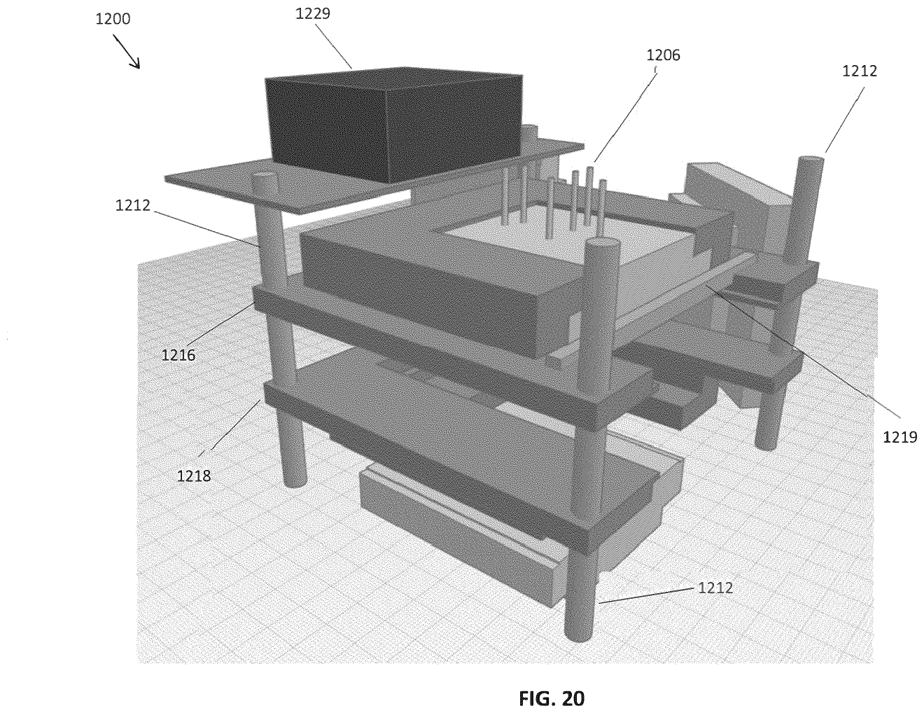

An alternative jig is described in FIGS. 18-20. FIG. 18 illustrates an embodiment of a multi-level test probe jig 1200. This multi-level test probe jig 1200 may include guide poles 1212 for aligning the various levels. The multiple levels may be movable up or down, as desired to enable proper contact and alignment of a pin adapter 1220 to the memory chip 202 or to the PCB 204, as required. This multi-level test probe jig 1200 may also include a holder 1229 for the electronic chip reader. The jig may comprise an upper level 1216 and a lower level 1218 for a pin adapter 1220. The upper level 1216 may use a pin adapter 1220 designed to contact portions of the memory chip 202 or the PCB 204 from the top. The lower level 1218 may use a pin adapter 1220 designed to contact portions of the memory chip 202 or the PCB 204 on the bottom. The pin adapter 1220 may comprise pins 1202, 1206 for connecting to a memory chip 202. The pin adapter 1220 may comprise rails 1228 for mating with slide rails 1226 on one of the levels, for easy placement of the pin adapter 1220 on either the upper level 1216 or the lower level 1218, or on any level. The rails on the various levels may further comprise a top portion for maintaining the pin adapter 1220 in a largely horizontal position to case alignment of the pins to the proper contact points on the memory chip 202 or the PCB 204. In the embodiment illustrated in FIGS. 18-20, the memory chip 202 and/or the PCB would be placed between the upper level 1216 and the lower level 1218. Under the proper circumstances only a single level might be used, depending on the contacts which would need to be made. A locking mechanism 1219 may be employed to lock the pin adapter 1220 into place. The pin adapter 1220 may also comprise an alignment locking mechanism 1222 for the back, which is designed to mate with a gap 1224 in the back of, in this example, the lower level 1218. Thus the pin adapter 1220 may fit smoothly so that the pin adapter slide rail 1228 mates within the top of the guide rails 1226. The pin adapter 1220 may be centered through the use of the pin adapter alignment locking mechanism 1222 mating with an alignment/centering gap 1224 in the back of the lower level 1218 (or of the upper level 1216, but which is not shown in the figures). FIGS. 19 and 20 show other perspectives of the multi-layer test probe jig.

### CONCLUSION

The current disclosure describes a non-destructive mechanism to read and write from an IoT device's onboard eMMC/eMCP chip 202. In an embodiment, an Amazon Echo Dot 2 may be used; however, the proposed methodology could work on most IoT devices 200 (and other similar mobile devices) that use eMMC for firmware and data storage. The proposed mechanism benefits from In-System Programming (ISP) pins, identified in a CT scan, available on the eMMC chip 202. These ISP pins permit direct communication with the eMMC chip 202 without involving the onboard CPU. A test probe jig 1200 was developed, which is a 3D printed fixture that attaches to the IoT device's PCB 204, holds pogo pins 1202, 1206 at specified locations to facilitate read-write operations from the eMMC chip 202.

A CT scan of the main printed circuit board 204 was critically important with the challenging task of finding the eMMC's hidden ISP pins, and their outbound connection points on both sides of the board 204. This methodology does not require FCC ID information about the targeted IoT device, because the CT scan and logic analyzer identify and verify the unpublished or hidden ISP pin locations. This ISP pin information is used to design a 3D Test Probe fixture 1200. The entire process of creating a 3D model of the test probe jig 1200 is a one-time effort for the research and practitioner community. After that, other interested parties, like forensic investigators or researchers, can share the 3D model design (the STL file) with their partners, who can print the test probe jig 1200 at their location. The above stated properties make the proposed non-destructive solution reproducible, portable, and affordable.

However, in case the command and data lines between the eMMC and CPU do not have a network TAP, or the manufacturer has applied industrial epoxy-like solutions on the PCB surface, the current methodology would require additional steps (e.g. dissolving the epoxy). The workarounds for the above stated situations, may require minor modification to the PCB.

The current methodology can expand to include more IoT devices and mobile computing devices that use eMMC memory chips, far beyond the single example detailed in this disclosure. The current version of the probe does not access the reset pin as it is not required for read operation, but it is critical for writing back to the chip. Since the analysis did identify the reset pin on the underside of the board, an additional feature could be added to the Jig to connect to the bottom side, allowing writing capability to the jig setup.

What is claimed is:

1. A method for downloading the memory of an IoT device without powering up the IoT device, the method comprising:
measuring a CT scan of a printed circuit board associated with the IoT device;
analyzing the CT scan to determine visible and hidden connection points to and from at least one memory chip on the printed circuit board;
printing a structure of a test jig specific to the printed circuit board;
assembling the test jig including adding pins into the structure for contacting at least one required connection point on the printed circuit board;
reading data from the at least one memory chip on the printed circuit board, using the test jig with the pins; and
creating a copy of the data from the at least one memory chip to an electronic device.

2. The method of claim 1, wherein the IoT device is a smart home or commercial-grade IoT device.

3. The method of claim 1, wherein the test jig comprises multiple layers for holding the printed circuit board during the reading step.

4. The method of claim 1, wherein the jig and its layers are produced by a 3D printer.

5. The method of claim 1, wherein the assembling step includes the use of spring-loaded pins contacting the connection points on the printed circuit board.

6. The method of claim 1, wherein the at least one memory chip is attached to the printed circuit board.

7. A system for downloading the memory of an IoT device without powering up the IoT device, the system comprising:
a means for measuring a CT scan of a printed circuit board associated with the IoT device;
a means for analyzing the CT scan to determine any hidden connections;
a means for printing a 3D test jig specific to the printed circuit board;
a means for assembling the test jig including adding pins for contacting the printed circuit board;
a means for copying, using the test jig with the pins, an electronic storage element of the IoT device; and
a means for transmitting the copy of the electronic storage element to an electronic device.

8. The system of claim 7, wherein the IoT device comprises a printed circuit board and has at least one memory chip for storing data.

9. The system of claim 7, wherein the test jig comprises multiple layers for pins and for holding the printed circuit board during the copying step.

10. The system of claim 7, wherein the printing means comprises a 3D printer.

11. The system of claim 7, wherein the assembling means uses spring-loaded pin connectors, for contacting the printed circuit board.

12. The system of claim 7, wherein the electronic storage element comprises an eMMC/eMCP chip or other memory chip.

13. A non-transitory computer readable medium for downloading the memory of an IoT device without powering up the IoT device, the non-transitory computer readable medium stores instructions that once executed by a processor, cause the processor to perform the steps of:
measuring a CT scan of a printed circuit board associated with the IoT device;
analyzing the CT scan to determine any hidden connections;
printing a mold for a test jig specific to the printed circuit board;
assembling the test jig including adding pins for contacting the printed circuit board;
copying, using the test jig with the pins, an electronic storage element of the IoT device; and
transmitting the copy of the electronic storage element to an electronic device.

14. The method of claim 13, wherein the IoT device comprises a printed circuit board and has at least one memory chip for storing data.

15. The method of claim 13, wherein the test jig comprises multiple layers for pins and for holding the printed circuit board during the copying step.

16. The method of claim 13, wherein the printing step is performed by a 3D printer.

17. The method of claim 13, wherein the assembling step includes the use of spring-loaded pin connectors, for contacting the printed circuit board.

18. The method of claim 13, wherein the electronic storage element comprises an eMMC/eMCP chip or other memory chip.
